(19) United States
(12) Patent Application Publication
(10) Pub. No.: US 2022/0318426 A1
(43) Pub. Date: Oct. 6, 2022

(54) KNOWLEDGE GRAPH PRIVACY MANAGEMENT

(71) Applicant: MICROSOFT TECHNOLOGY LICENSING, LLC, Redmond, WA (US)

(72) Inventors: Helge Grenager SOLHEIM, Oslo (NO); Jan-Ove Almli KARLBERG, Troms (NO); Bernt LERVIK, Oslo (NO); Vidar Tveoy KNUDSEN, Oslo (NO); Daniela LEPRI, Oslo (NO); Elvira MAKHMUTOVA, Ski (NO); Marta Emilia NOWAKOWSKA, Chelmza (PL); Tor KREUTZER, Tromso (NO)

(21) Appl. No.: 17/320,368

(22) Filed: May 14, 2021

Related U.S. Application Data
(60) Provisional application No. 63/168,971, filed on Mar. 31, 2021.

(51) Int. Cl. G06F 21/62; G06N 5/02

(52) U.S. Cl. CPC G06F 21/6245; G06N 5/02

(57) ABSTRACT

The technology described herein protects the privacy of data stored in a knowledge graph (“graph”) by enforcing privacy policies when returning information in response to a query or other attempt to extract information from the graph and/or about the graph. In one aspect, unauthorized information is trimmed from the information output in response to a query. In other words, the privacy policy for a knowledge graph is enforced during the information extraction process. This is in contrast to other methods that attempt to enforce privacy policies at the information ingestion process or through some other service-level process after information is output from the graph. The privacy policies may be stored in a node of the graph.

### CROSS-REFERENCE TO RELATED APPLICATIONS

This application claims the benefit of U.S. Provisional Application No. 63/168,971, filed Mar. 31, 2021, which is incorporated herein by reference in its entirety.

### BACKGROUND

Data privacy is an important issue for users and organizations alike. Many business applications provide useful insights or services by analyzing information about actions taken by one or more users within an organization. For example, applications are available to help people prepare for a meeting by looking for documents or other objects that meeting participants have used recently. While the results can indeed help a person prepare for the meeting, the results can also show what documents a small group of people (e.g., meeting attendees) are using, even if the exact person using the document is not identified. Perceived privacy concerns raised by this type of service have caused many organizations not to use these services. Users and organizations generally lack the ability to control the use of personal and organizational information that these types of services use in a granular and efficient way. Some of the challenges around managing privacy controls are caused by how organizational information is stored in graph forms.

For efficient retrieval and analysis, organizational information may be stored in a knowledge graph (e.g., information graph). Knowledge graphs can contain multiple entities that have relationships with one another. An entity may broadly be defined as a named noun or a named object. Entities may be organized by entity-type. Entity-types could include, for exemplary purposes only, a person, a location, a place, a business, an organization, a movie title, a book, a song, etc. There are many examples of entity-types, and this list is intended to be a non-exhaustive list of exemplary entity-types. Relationships connect the entities and form the graph “edges.” For example, entity instances within the “document” entity-type could be connected to the “person” entity-type by the relationship “author.” Entity-types may have multiple entity instances. For example, each person in the person entity-type is an instance of the person entity. Entity-types, relationships, and entity instances may be described as knowledge graph characteristics. Current methods often manage privacy concerns within a knowledge graph at the input stage by simply not adding private information to the graph in the first place. This approach may require a different graph to be created for each application using the organizational information or force all applications using the graph data to use the same privacy rules.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The technology described herein protects the privacy of data stored in a knowledge graph (“graph”) by enforcing privacy policies when returning information in response to a query or other attempt to extract information from the graph and/or about the graph. The policy can be enforced against knowledge graph objects, which include nodes and edges, and information about these objects (e.g., how many edges intersect a node). The privacy policies can govern both the graph information itself and analytics about the graph information. An example of graph information may be the identity of one or more users who accessed a document, which may be indicated by an edge or edge property in the graph. The analytics about that graph information may include how many users accessed the document, which may not be stored directly in the graph, but can be determined by analyzing information in the graph (e.g., by counting edges). With the analytics information, a number of users may be provided without the individual users themselves being identified.

In one aspect, unauthorized information that is responsive to a query is trimmed from the query response. In other words, the privacy policy for a knowledge graph is enforced during the information extraction process. This is in contrast to conventional methods that attempt to enforce privacy policies at the information ingestion process or through another service-level process after information is output from the graph.

The privacy policies may be stored in a node of the graph. The privacy policies can record privacy status information associated with one or more knowledge graph objects (e.g., edge, edge metadata, node, and node metadata). The privacy status can take the form of opt-in (i.e., allow access) or opt-out (i.e., deny access). In one aspect, only opt-in information is stored, and opt-out serves as a default status. In another aspect, only opt-out information is stored, and opt-in serves as the default status. Storing only one status or the other conserves computer resources including computer storage and look up time (e.g., reduces latency).

The privacy policy may include a policy scope that identifies one or more knowledge graph objects to which the privacy status (e.g., opt-out) applies. A privacy-policy collection system may allow a privacy status's scope to be specified for an entire organization, a group of people within the organization, or an individual user. The scope of a privacy policy specifies users to which the policy applies. The privacy policy may be specified on a service-by-service basis. One service may have full access to graph information while another service has limited access. The privacy policy may further differentiate between audiences. This, as an example, allows a user to access his or her own information, while denying or limiting the access of others to the information. Similarly, information can be shared with members of a designated group without giving access to people outside the group.

A privacy-policy enforcement system compares an information request and the context of that request to applicable privacy policies. In an aspect, a query is submitted with a security token that may identify an audience for the query result and a service that originated the query. Depending on the result of the comparison, all information responsive the query or a portion thereof may be provided. If a portion of the responsive information is protected by a privacy policy, then that portion is omitted from the response, and the portion of information that is not protected by the privacy policy is output to the requesting entity.

### BRIEF DESCRIPTION OF THE DRAWINGS

The technology described herein is illustrated by way of example and not limitation in the accompanying figures in which like reference numerals indicate similar elements and in which:

FIG. 1 is a block diagram of an example operating environment suitable for implementations of the present disclosure;

FIG. 2 is a diagram depicting an example computing architecture suitable for implementing aspects of the present disclosure;

FIG. 3 shows a knowledge graph, in accordance with an aspect of the technology described herein;

FIG. 4 shows a knowledge graph with embedded privacy policies, in accordance with an aspect of the technology described herein;

FIGS. 5-7 are flow diagrams showing additional exemplary methods of managing privacy settings, in accordance with an aspect of the technology described herein; and

FIG. 8 is a block diagram of an exemplary computing environment suitable for use in implementing aspects of the technology described herein.

### DETAILED DESCRIPTION

The various technology described herein are set forth with sufficient specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The technology described herein protects the privacy of data stored in a knowledge graph (“graph”) by enforcing privacy policies when returning information in response to a query or other attempt to extract information from the graph and/or about the graph. The policy can be enforced against knowledge graph objects, which include nodes and edges, and information about these objects (e.g., how many edges intersect a node). The privacy policies can govern both the graph information itself and analytics about the graph information. An example of graph information may be the identity of one or more users who accessed a document, which may be indicated by an edge or edge property in the graph. The analytics about that graph information may include how many users accessed the document, which may not be stored directly in the graph, but can be determined by analyzing information in the graph (e.g., by counting edges).

In one aspect, unauthorized information that is responsive to a query is trimmed from the query response. In other words, the privacy policy for a knowledge graph is enforced during the information extraction process. This is in contrast to conventional methods that attempt to enforce privacy policies at the information ingestion process or through another service-level process after information is output from the graph.

Under conventional methods, privacy policies may be enforced at the time information is input (e.g., ingested) into the knowledge graph. In this scenario, information that is inconsistent with the privacy policy is not stored in the graph. The information deemed private may be stored in a separate system, but is not stored in the graph itself. This approach has several disadvantages. First, a different graph may be required for each service accessing the graph information that is associated with a different privacy policy. In contrast, the technology described herein allows a single knowledge graph to be accessed by different services, while enforcing different privacy policies against the different services. Using a single knowledge graph represents a significant conservation of computing resources.

A second advantage of the technology described herein, when compared to conventional methods of enforcing privacy policies at information ingestion, is the ability of a user to change a privacy policy without the loss of functionality. By storing all information in a knowledge graph, whether subject to a privacy policy or not, the information can later be available to provide access to a service and/or functionality the user did not initially want or enable.

In some embodiments, the technology described herein comprises three components. First, the knowledge graph, which may be represented in any suitable architecture. Second, the privacy-policy collection system. Third, the privacy-policy enforcement system.

The privacy-policy collection system provides an interface through which users may specify their privacy preferences. The preferences may be used to form a privacy profile for the user. The user profile may be stored outside of the knowledge graph. The privacy preferences may be used to form a user privacy policy. A privacy policy comprises an opt-out (or opt-in) status and a scope defining one or more objects (e.g., edge, edge metadata, node, and node metadata) to which the status applies. The privacy policies are stored for use by the privacy-policy enforcement system. In one aspect, the privacy policies are stored in the knowledge graph being managed. The privacy policies may be stored in a node of the graph as a user opt-out record. In one aspect, only opt-in information is stored, and opt-out serves as a default status. In another aspect, only opt-out information is stored, and opt-in serves as the default status. Storing only one status or the other conserves computer resources including computer storage and look up time (e.g., reduces latency). As used herein, an opt-out is any instruction to deny access to an object or information about an object. The use of the term opt-out does not necessarily mean that the system has a default opt-in status; however, the technology may be used with a system that has a default opt-in status. As used herein, an opt-in is any instruction to allow access to an object or information about an object. The use of the term opt-in does not necessarily mean that the system has a default opt-out status.

The privacy-policy collection system may allow the scope of a privacy status (e.g., opt-in or opt-out) to be specified for the entire organization, a group of people within the organization, or an individual user. The scope of a privacy policy specifies people to which the policy applies. The privacy policy may be specified on a service-by-service basis. One service may have full access to graph information while another service has limited access. The privacy policy may further differentiate between audiences. This, as an example, allows a user to access his or her own information, while denying or limiting the access of others to the information. Similarly, information can be shared with members of a designated group without giving access to people outside the group.

The privacy-policy enforcement system compares an information request and the context of that request to applicable privacy policies. In an aspect, a query is submitted with a security token that may identify an audience for the query result and a service that originated the query. Depending on the result of the comparison, all information responsive the query or a portion thereof may be provided. If a portion of the responsive information is protected by a privacy policy, then that portion is omitted from the response, and the portion of information that is not protected by the privacy policy is output to the requesting entity.

Having briefly described an overview of aspects of the technology described herein, an exemplary operating environment in which aspects of the technology described herein may be implemented is described below in order to provide a general context for various aspects.

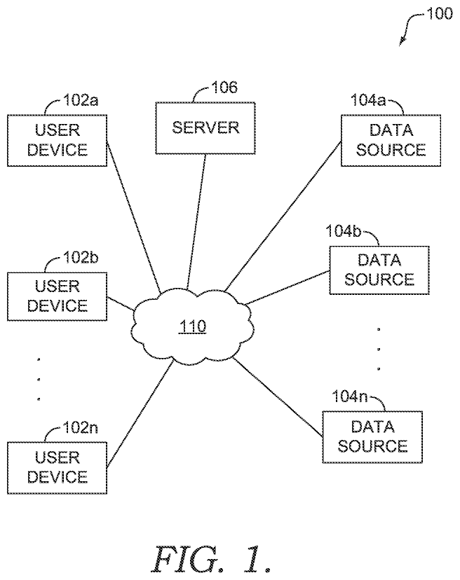

Turning now to FIG. 1, a block diagram is provided showing an example operating environment 100 in which some aspects of the present disclosure may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

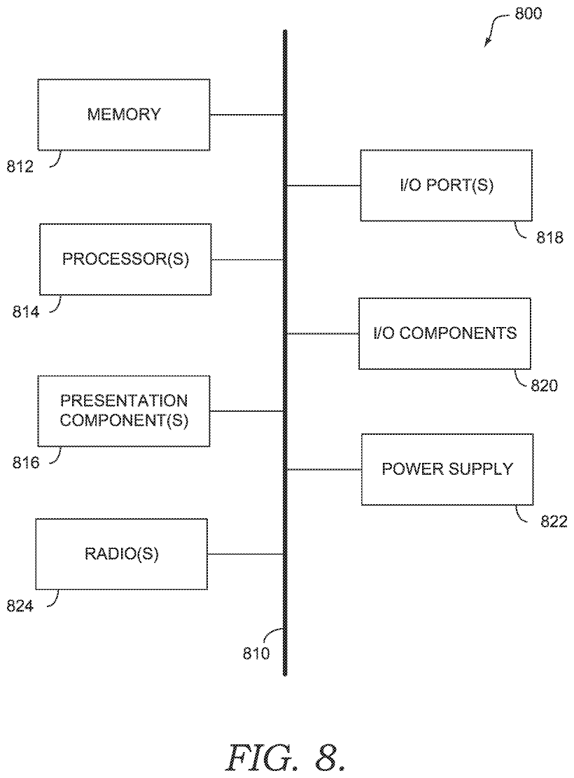

Among other components not shown, example operating environment 100 includes a number of user devices, such as user devices 102a and 102b through 102n; a number of data sources, such as data sources 104a and 104b through 104n; server 106; and network 110. Each of the components shown in FIG. 1 may be implemented via any type of computing device, such as computing device 800 described in connection to FIG. 8, for example. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks.

User devices 102a and 102b through 102n can be client devices on the client-side of operating environment 100, while server 106 can be on the server-side of operating environment 100. The user devices can facilitate generation of objects that are stored in a knowledge graph. For examples, the user devices can create and edit documents that are stored in the knowledge graph as a node. The record of interactions, such as views, edits, may also be saved in the knowledge graph as edges. The devices can belong to many different users and a single user may use multiple devices.

Server 106 can comprise server-side software designed to work in conjunction with client-side software on user devices 102a and 102b through 102n to implement any combination of the features and functionalities discussed in the present disclosure. For example, the server 106 may run the information management system 201, which manage access to and use of information in a knowledge graph. The server 106 may receive received digital assets, such as files of documents, spreadsheets, emails, social media posts, and the like for storage, from a large number of user devices belonging to many users. This division of operating environment 100 is provided to illustrate one example of a suitable environment, and there is no requirement for each implementation that any combination of server 106 and user devices 102a and 102b through 102n remain as separate entities.

User devices 102a and 102b through 102n may comprise any type of computing device capable of use by a user. For example, in one aspect, user devices 102a through 102n may be the type of computing device described in relation to FIG. 8 herein. By way of example and not limitation, a user device may be embodied as a personal computer (PC), a laptop computer, a mobile device, a smartphone, a tablet computer, a smart watch, a wearable computer, a fitness tracker, a virtual reality headset, augmented reality glasses, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, or any combination of these delineated devices, or any other suitable device.

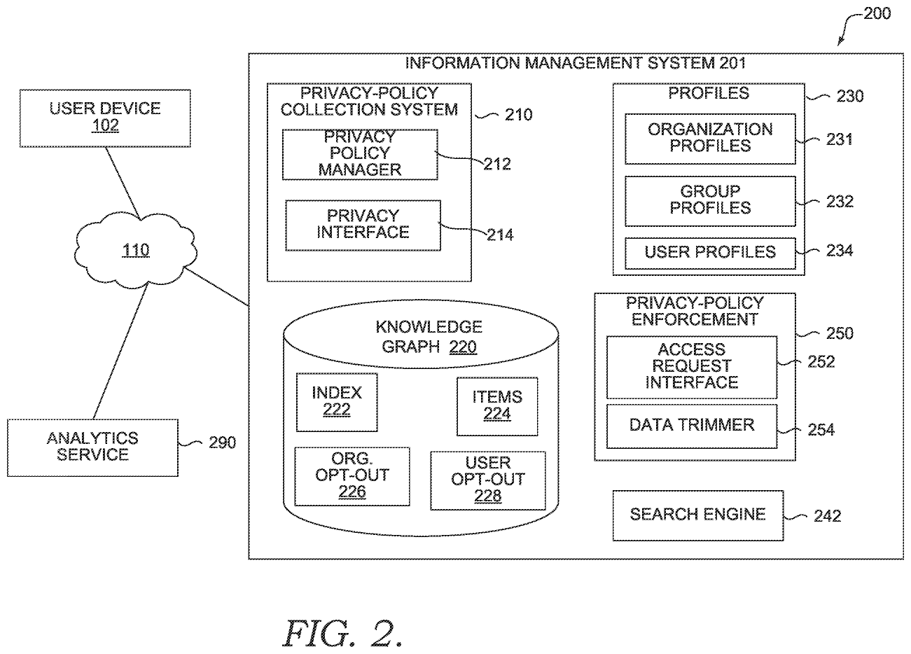

Data sources 104a and 104b through 104n may comprise data sources and/or data systems, which are configured to make data available to any of the various constituents of operating environment 100, or system 200 described in connection to FIG. 2. For example, the data sources may comprise email servers, social media servers, or other sources of objects that may be stored in a knowledge graph managed by the technology described herein. Data sources 104a and 104b through 104n may be discrete from user devices 102a and 102b through 102n and server 106 or may be incorporated and/or integrated into at least one of those components.

Operating environment 100 can be utilized to implement one or more of the components of system 200, described in FIG. 2, including components for collecting user data, identifying user interests, receiving user queries related to a task, responding to the query.

Referring now to FIG. 2, with FIG. 1, a block diagram is provided showing aspects of an example computing system architecture suitable for implementing some aspects of the present disclosure and designated generally as system 200. System 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Example system 200 includes network 110, which is described in connection to FIG. 1, and which communicatively connects components of system 200 including user device 102, analytics service 290, and information management system 201. The information management system 201 includes a privacy-policy collection system 210 (and its components 212 and 214), knowledge graph 220 (and its components 222, 224, and 226, and 228), profiles 230 (and organization profiles 231, group profiles 232, user profiles 234), search engine 242, and privacy-policy enforcement component (and its components 252 and 254). These components may be embodied as a set of compiled computer instructions or functions, program modules, computer software services, or an arrangement of processes carried out on one or more computer systems, such as computing device 800 described in connection to FIG. 8, for example.

In one aspect, the functions performed by components of system 200 are associated with one or more applications, services, or routines. In particular, such applications, services, or routines may operate on one or more user devices (such as user device 102a), servers (such as server 106), may be distributed across one or more user devices and servers, or be implemented in the cloud. Moreover, in some aspects, these components of system 200 may be distributed across a network, including one or more servers (such as server 106) and client devices (such as user device 102a), in the cloud, or may reside on a user device, such as user device 102a. Moreover, these components, functions performed by these components, or services carried out by these components may be implemented at appropriate abstraction layer(s), such as the operating system layer, application layer, hardware layer, etc., of the computing system(s). Alternatively, or in addition, the functionality of these components and/or the aspects described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with reference to specific components shown in example system 200, it is contemplated that in some aspects functionality of these components can be shared or distributed across other components.

Continuing with FIG. 2, the information management system 201 is used to receive, track, manage and store digital assets, such as document files, spreadsheet files, presentation files, email files, group chats, and the like. These digital assets may be entities represented by nodes in a knowledge graph. The information management system 201 may be provided for one or more organizations, such as a corporation or partnership. The information management system 201 may be capable of keeping a record of various versions of digital assets created and modified by different users (e.g., history tracking). An information management system may have some overlap with or alternatively be described as a content management system, enterprise content management (ECM) system, digital asset management, document imaging, workflow system, and records management system.

The information management system 201 may store information in one or more servers. The servers may be private servers. The servers could be provided by a service provider, in which case the organization and/or devices may be described as a tenant. Communications between components of the system may be through various appropriate application program interfaces (APIs) including a tenant API (TAPI) or personal API (PAPI). Aspects of the technology described herein are not limited to the information management system 201 described herein.

The privacy-policy collection system 210 is responsible for collecting privacy information from users, groups, and organizations. The collected information is processed and stored within the knowledge graph 220 in the user opt-out record 228 or the organizational opt-out record 226. The privacy-policy collection system 210 may also store privacy information in the profile component 230, which includes the organizational profile 231, a group profile 232, or user profile 234. Similarly, privacy information may be retrieved from the organizational profile 231, the group profile 232, or the user profile 234.

The privacy policy manager 212 receives information from the privacy interface 214 and updates the user opt-out record 228 or the organizational opt-out record 226 accordingly. The updating can include adding information to or subtracting information from the user opt-out record 228 or the organizational opt-out record 226. In one aspect, the privacy policy manager 212 is responsible for synchronization of data in the user opt-out record 228 and/or the organizational opt-out record 226. The synchronization may follow a preference system to manage conflicts between inconsistent privacy instructions. In this sense, the synchronization process may reconcile inconsistent instructions between organizations, groups, and users. In an aspect, only the resulting status is stored within the knowledge graph 220, while inputs to determining the result are stored elsewhere such as in the relevant profiles.

A user, group, or organization may have inconsistent privacy policies governing the same object, audience, and/or requesting service. In one aspect, the most restrictive opt-out instruction governs. In other aspects, a hierarchy may be applied to reconcile inconsistencies. For example, a user's expressed privacy preferences may govern the result.

The privacy policy manager 212 can manage multi-variable privacy policies. The variables can include an audience for information, a service requesting the information, and detailed criteria defining information the policy is applied to. The audience for the information can be specified as a list of users or predefined groups. If the audience is not specified in a privacy policy, then it may be assumed to apply to all users within an organization. The privacy policy manager 212 may be responsible for keeping the organizational opt-out record 226 and/or the user-opt out 228 records up to date. The privacy policy manager 212 can work in a push or pull environment. For example, the privacy policy manager 212 can receive indications of changes made to privacy policies from the privacy interface 214 and make changes to the organizational opt-out record 226 and/or the user-opt out 228 records in response. In another example, the privacy policy manager 212 can monitor profiles or other sources of privacy information and use this information to make changes to the organizational opt-out record 226 and/or the user-opt out 228 records as needed.

The privacy interface 214 may present a list of groups for a user or organization to select as allowed or restricted. The privacy interface 214 may be caused to be displayed via a user device 102. The privacy interface 214 may enable individual users to be looked up and selected. These users may be designated as allowed or restricted in various aspects. In other words, the privacy interface 214 may provide an opportunity for a user to block access to designated groups or individuals or to allow access to individuals and groups. Preformed groups can include ad hoc groups, such as project teams, or more permanent groups based on organizational structure (e.g., human resources, sales, legal, manufacturing, travel). Examples of other preformed groups could include a manager and all direct reports to the manager. Groups can also be formed through a nearest neighbor analysis of the knowledge graph 220. Essentially, the nearest neighbor analysis may look for groups of people interacting with the same objects (e.g., documents).

The privacy interface 214 may present a list of services for a user or organization to select as allowed or restricted. For example, the analytics service 290 may be granted limited access to information, while the search engine 242 is granted full access.

The privacy interface 214 may enable a user or organization to define what information is allowed or restricted under a privacy policy. In aspects, the privacy interface 214 allows the user or organization to allow or restrict specific edges in the knowledge graph. Edges may include user actions or relationships within the knowledge graph. For example, a first user viewing a document may form a first edge between a node representing the user and a node representing the document. The same user modifying the document may form a second edge between the user node and document node.

The privacy interface 214 may allow a user or organization to specify in a privacy policy that information about edges, including aggregate information, be restricted. Aggregate information can include the number of edges connecting to a node without identifying other information about the edges. For example, an analytics service 290 may seek to understand which documents are trending within an organization or group within the organization. Trending documents are those documents having the most interactions within a designated time. For example, a trending documents interface may show documents ranked according to the views in the last week. If a user restricts other users' access to his “view records,” then a requesting service would not receive information regarding the user's view records. Thus, if ten users viewed a document including the user who restricted access, then a result provided in response to a query may be nine users, assuming no other users also restricted access to their views. In this example, the restricted information is trimmed from the result even though it exists in the knowledge graph 220.

The privacy interface 214 may allow users or organizations to specify an edge type that is restricted in general, or do so on a node-by-node basis. For example, a user organization may restrict an analytics service's access to “view” or “modification” information about a sensitive document. This would, for example, prevent the document from being presented as trending within a group interface or organizational interface.

This is different from blocking access to the document itself, which may be a node in the knowledge graph. Blocking access to the document itself may prevent a user or program from accessing (e.g., opening, viewing, copying) the document content. The document is not an edge in this example. Edges represent user actions with the document. A user can restrict access to the edges, without restricting access to the node document. Thus, when an edge representing a view of the document by a first user is restricted, a second user may be able to open the document, but not see that the first user viewed the document. As mentioned, the access to the edges may depend on the program seeking access to information. For example, an analytics program may not be given access to an edge representing a view of the document by the user, but the document-editing program may be given access to the edge (view) and display the view data within the document-editing program.

The knowledge graph 220 is a repository for information that can be organized as a semantic graph. The technology described herein can work with various knowledge graph architectures including Labelled-Property Graphs (LPGs), and Resource Description Framework (RDF) based graphs. With a labelled-property graph, nodes and edges both can have metadata (properties) assigned to them in the form of key-value pairs. They may be used for querying and analyzing paths through the graph. RDF based graph databases store data in the form of triple-statements (subject-predicate-object). The predicates (relationships) that join nodes together confer semantic meaning upon the data.

Knowledge graphs can contain multiple entities that have relationships with one another. An entity may broadly be defined as a named noun. Entities may be organized by entity-type. Entity-types could include, for exemplary purposes only, a person, a location, a place, a business, a digital asset, an organization, a movie title, a book, a song, etc. There are many examples of entity-types, and this list is intended to be a non-exhaustive list of exemplary entity-types. The entity types may be nodes in the graph. Relationships connect the entities and form the graph “edges.” For example, entity instances within the “document” entity-type could be connected to the “person” entity-type by the relationship “author.” Entity-types may be associated with multiple entity instances. For example, each person in the person entity-type is an instance of the person entity.

Knowledge graphs are defined by a schema and composed of nodes and edges connecting the nodes. The nodes represent entities, which can be of different types. The edges that connect the nodes represent relationships between the entities. The relationships can be called graph properties. For example, in the document domain, nodes represent core entity-types for the document domain, such as the names of a document (Vlogging 101), the name of a user (e.g., Vidar), and a date the document was created (e.g., 2017). Relationships in the document domain include examples like “view,” “edit,” and “author.” Thus, the relationship “author” could connect entity instance Vidar and entity instance Vlogging 101.

The index 222 stores information that can be used to find or retrieve objects (e.g., nodes, edges) represented within the knowledge graph 220. For example, the index 222 may store a location where a file may be retrieved. The index 222 may store relationship information, such as views, that form edges within the knowledge graph. In an aspect, the index 222 can be used to find objects in the knowledge graph 220.

The digital assets 224 include the files or other information that are represented in the knowledge graph 220. The digital assets 224 may be represented as nodes in the knowledge graph 220. The graph 220 itself may store information about the digital asset 224 as a record, but the digital asset may be stored in and retrieved from a separate computer storage. For example, the digital assets 224 may include documents or other objects stored elsewhere.

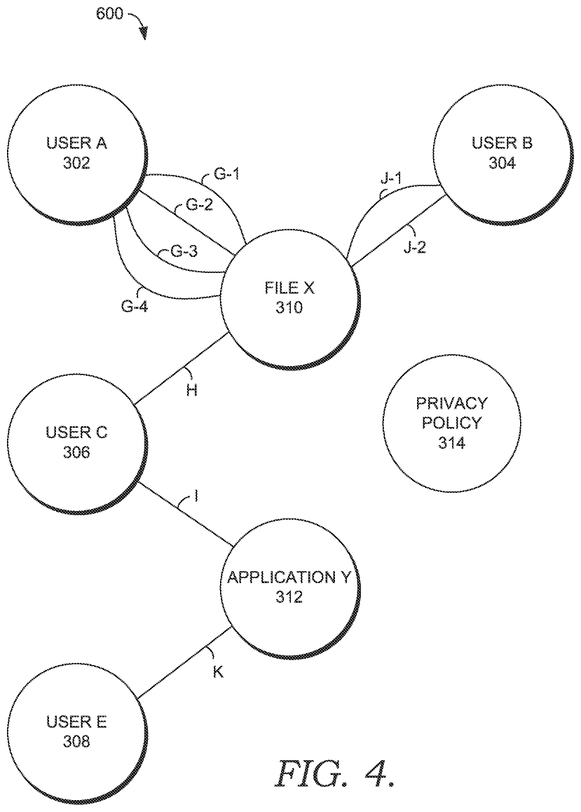

The organizational opt-out record 226 includes privacy policies that apply to the entire organization. The organizational opt-out record 226 may be stored as a node of the knowledge graph, as shown in FIG. 4. In one aspect, the opt-out record 226 only specifies knowledge graph objects that are restricted, possibly conditionally (e.g., only restricted to a designated requesting service or specified audience). In this implementation, all other objects not designated in the opt-out record 226 are assumed accessible under all conditions. Aspects of the technology described herein are not limited to use with an opt-out implementation. For example, an alternative implementation could include a status for each object within a knowledge base or for each class of object within a knowledge base. Using the opt-out implementation can conserve computer resources by eliminating a need to assign a designation to most objects in a knowledge graph when most objects are unrestricted. Conversely, an opt-in record may be used in an organization that chooses to restrict access to a majority of objects in a knowledge base.

It should be noted that organizations may assign different privacy statuses (e.g. opt-in, opt-out) to individual users or groups within the organization. For example, an organization may assign an opt-out privacy status to an executive and an opt-in privacy status to a receptionist. These privacy statuses may be recorded in the user opt-out record 228 if they only apply to a user or groups of users and do not apply to the entire organization. In this example, the opt-out record 228 could be updated to include the executive. In other words, the description “organizational” opt-out record indicates the policy applies organization wide rather than designating a source of the instruction.

The user opt-out record 228 comprises a privacy policy for one or more individual users. These may be described as user privacy policies and apply to only a single user. As described herein, the privacy policies for individual users may restrict access at different levels of detail based on a requesting service, an intended audience, and/or the specific content requested, among other possible variables. In one aspect, if a user does not specify an individual privacy policy, then no record for that user may appear in the user opt-out record 228. In other implementations, each user has a privacy policy and/or opt-out record even if no restrictions are defined within the policy/record. The user opt-out record 228 may be stored as a node of the knowledge graph, as shown in FIG. 4.

The organization profiles 231 store information about the organization including information about the organization's privacy policy. The organizational profiles 231 may be stored apart from the knowledge graph 220. Privacy policy information from the organizational profiles 231 may be stored in the organizational opt-out record 226, if the implementation is organization wide, or in the user opt-out record 228, if the restriction originates with the organization but applies on the user level. For example, an organization could choose to restrict access to some or all actions taken by a particular class of employees, such as everyone in purchasing or all executives. These types of restrictions originating with the organization could be stored in a user profile for the impacted individuals. In addition to privacy policy information, the organizational profiles 231 may include an organizational hierarchy. In some aspects, the organizational hierarchy can be used to form groups. These groups may have their own profiles stored in the group profiles 232 record. The organization profiles 231 may also store information unrelated to privacy information, such as policies for adding and removing information from the knowledge graph or otherwise governing knowledge graph 220 operations.

The group profiles 232 define a group of individual users and a privacy policy that applies to these individuals. In one aspect, a group privacy policy allows access to information when the audience is the group as a whole, an individual in the group, or a subset of individuals in the group. A group privacy policy may deny access when its intended audience includes one or more users outside of a group. Though defined as a group policy, the restrictions may be implemented by including the restrictions in individual user profiles and/or user-opt out record of group members. The group profiles 232 may also store information unrelated to privacy information.

The user profiles 234 store privacy information for individual users. The user profiles 234 may also store information unrelated to privacy information. Information from the user profiles 234 may be used to populate privacy policy information in the user opt-out record 228.

The search engine 242 is enabled to find information in the knowledge graph and is an example of a consumer of graph information. The search engine 242 can consume both the information stored in the graph and analytical information about the stored information. For example, the search engine may rank documents stored in the graph according to views, edit date, author influence, and the like.

The privacy-policy enforcement component 250 enforces the various privacy policies to make sure the information communicated from the knowledge graph complies with these policies. In one aspect, the privacy policies may be inspected in sequential order to make a decision about whether information is restricted or allowed. In one aspect, the organizational privacy policies are inspected first. As described herein, the organizational opt-out record 226 may store the relevant privacy policies. A request for information may be received by the access-request interface 252. In one aspect, the request takes the form of a query. The request may include specific information, such as a definition of the requested information. The request may also specify an intended audience and a requesting service. In one aspect, the request is submitted with a token that includes information, such as the requesting service, search parameters, and intended audience.

In response to receiving the request, the organizational privacy policies may be inspected by the privacy-policy enforcement component 250 to determine if the requested information is governed by a privacy policy. For example, the privacy policies may be inspected to determine if a privacy policy is applicable to a particular requesting service. The information requested is evaluated to determine whether any portion thereof is restricted by an organizational policy. The audience specified by the request may also be used to determine whether any portion of the requested information is restricted. The restricted information may be identified and trimmed from any results provided. Objects restricted by the organizational privacy policy may be described as organizationally restricted objects. If at least some objects exist that are responsive to the query and are not restricted, then user privacy policies may be evaluated. Otherwise, a response may be provided indicating that no objects are responsive to the query.

The user privacy policies may be evaluated in the same or similar way that organizational policies are evaluated. The responsive information may be first identified and then compared against privacy policies to see if any of the user privacy policies restrict the requested information. Any restricted information may be described as user-restricted objects. The result set may be generated to include objects that are responsive the query but that are not user restricted objects or organizationally restricted objects. For example, in response to a query seeking a number of views for a plurality of documents, a response may be provided that is less than the total number of actual views. The number provided would not include views associated with users having privacy policies or organization privacy policies restricting the records.

The data trimmer 254 is responsible for trimming restricted information from a result set prior to communicating information from the knowledge graph and/or information management system 201. The trimming can occur in a number of different ways. For example, the trimming can occur by first identifying objects that are not restricted and then generating a result based on only these objects, while ignoring restricted objects.

The analytics service 290 is just one example of a service that can submit queries to the knowledge graph. As mentioned, these queries may be received by the access request interface 252. The analytics service can provide a number of services to users. The services may be specific to a single user or a group. The single user or group may be indicated as the audience of a query. Different services may be provided from different information from the graph. Privacy policies may apply to specified services offered by the analytics service in some cases, or to the underlying requested data. For example, the user may specify a privacy policy based on one or more variables of how the information will be used. For instance, the user may specify that his email views may be used to identify trending emails but not to generate a report for a particular sender about how many people read the sender's email.

An example service includes generating a report indicating how many people opened an email and the average time they spent reading that email. The organization may specify which emails (e.g., qualifying emails) are eligible for this service. For example, a qualifying email may be an email message that is sent to five or more qualifying recipients. This prevents a recipient from being singled out as having not opened an email. This is an example of how organizational and personal privacy policies may work together. The organizational policy may specify an email report may only be generated for qualifying emails. Thus, a query from the analytics service 290 may request “open” and “read” data for a user's emails. In response, the service may receive information for emails sent to five or more people who have authorized access to their open and read information. That is, open and read information for users who have restricted access thereto would not be provided or used to determine whether an email is qualified for reporting.

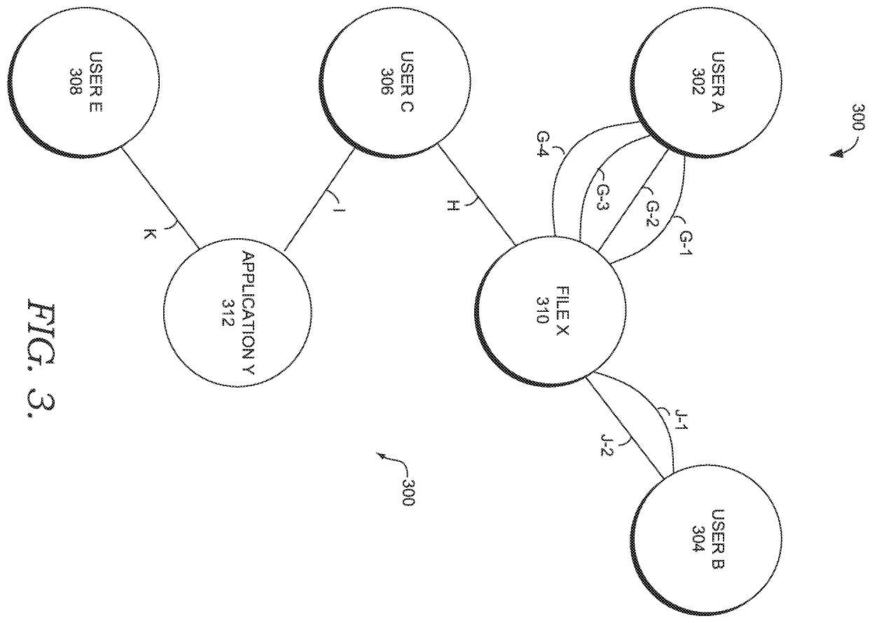

FIG. 3 is a schematic diagram of an example knowledge graph 300, according to some embodiments. A knowledge graph is a pictorial representation or visualization for a set of objects where pairs of nodes or “vertices” are connected by edges or “links.” Each node represents a particular position in a one-dimensional, two-dimensional, or three-dimensional (or any other dimensions) space. A node is a point where one or more edges meet. An edge connects two nodes. Specifically, the knowledge graph 300 includes the nodes of: “user a 302,” “user b 304,” “file x 310,” “user c 306,” “application y 312,” and “user e 308.” The knowledge graph further includes the edges K, I, H, J-1, J-2, and G-1, G-2, G-3, G-4.

The knowledge graph 300 shows the relationships between various users and digital assets, such as file x 310 and application y 312. It is understood that these digital assets are representative only. As such, the digital assets may alternatively or additionally include calendars that users have populated, groups that users belong to, chat sessions that users have engaged in, text messages that users have sent or received, and the like. In some embodiments, the edges represent or illustrate a specific user interaction (e.g., a download, sharing, saving, modifying or any other read/write operation) with specific digital assets.

Representing digital assets as nodes allow users to be linked in a more comprehensive manner than has been available with conventional techniques. For example, application y 312 may represent a group container (e.g., MICROSOFT TEAMS) where electronic messages are exchanged between group members. Accordingly, the knowledge graph 300 may illustrate which users are members of the same group. In another illustrative example, the knowledge graph 300 may indicate that user a 302 downloaded or otherwise accessed file x 310 at a first time (represented by edge G-1), a second time (represented by edge G-2), a third time (represented by edge G-3), and a fourth time (represented by edge G-4). The graph 300 may also illustrate that user b 304 also downloaded the file x 310, as represented by the edge J-1 and wrote to the file x 310 at another time, as represented by the edge J-2. Accordingly, the knowledge graph 300 may illustrate a much stronger relationship between the user a 302 and file x 310 relative to user b 304, based on the edge instances illustrated between the respective nodes (e.g., user a 302 downloaded file x 310 more times relative to user b 304). Other factors associated with an edge may be considered when determining an analytic result (e.g., strength of relationship). For example, the duration of a viewing instance that is represented by edge G-1 may be stored as a property of the edge G-1 and used to produce the analytic result. Edges between a file and a user can represent any of a large number of actions that can be taken with reference to the file. A non-exclusive list of user actions that can create edges in the knowledge graph 300 include, access modification, approve, check in, copy, delete, delete a version, deliver a secure link, designating an official version, download, edit (content), edit profile, email link, email copy, new version, open, move, print, rename, sign, and view. Each of these actions may be associated with metadata describing the action. For example, the date of the action and/or the duration of the action, if applicable, may be stored as metadata that is associated with the edge.

In aggregate, the knowledge graph 300 indicates user a 302 interacted with file x 310 four times (edges G-1 through G-4), user b 304 interacted with file x 310 twice (J-1 and J-2), and user c 306 interacted with file x 310 once (H). The knowledge graph 300 further indicates that user c 306 interacted with application y 312. The knowledge graph 300 further indicates that user e 308 also interacted with application y 312.

In some embodiments, a “distance” corresponds to a number of edges in a shortest path between node U and node V. In some embodiments, if there are multipole paths connecting two nodes, then the shortest path is considered as the distance between two nodes. Accordingly, distance can be defined as d(U,V). For instance, the distance between user a 302 and file x 310 is 1 (e.g., because there is only 1 edge (any of G-1 through G-4)), the distance between user a 302 and user b 304 (and user c 306) is 2, whereas the distance between user a 302 and user e 308 is 4 between user a 302 and user e 308). Accordingly, user a's 302 two closest connections are user c 306 and user b 304. This distance may be used to define groups within the group profiles 232.

FIG. 4 is similar to FIG. 3, but includes a privacy policy node 314. The privacy policy node 314 may be a floating node that is not connected to any of the other nodes in the graph 300. Including the privacy policy node 314 in the graph 300 can compartmentalize the privacy information within the same system that manages the information in the graph 300. In various aspects, graphs may be ported to various systems for various reasons. The porting process could create a vulnerability if the privacy policy were stored separately from the graph. Integrating the privacy policy into a node of the graph can help diminish or mitigate this vulnerability. However, in other aspects, the privacy policies may be stored outside of the knowledge graph 300.

### Exemplary Methods

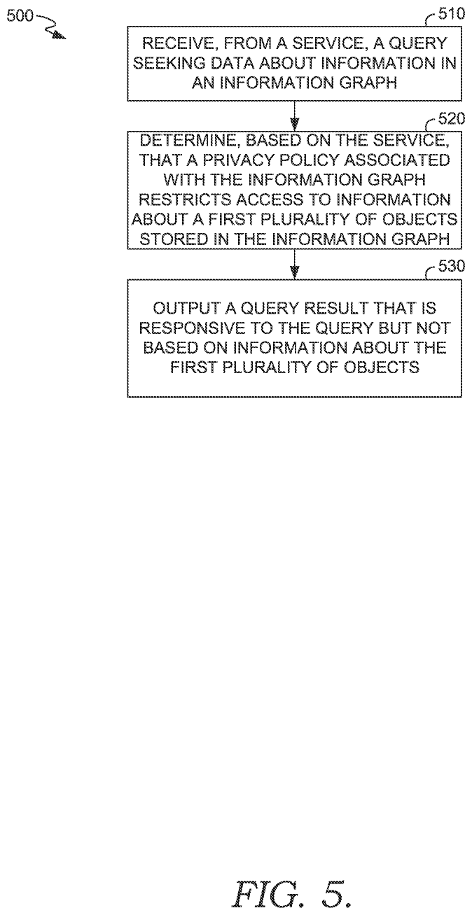

Now referring to FIGS. 5-7, each block of methods 500, 600, and 700, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The method may be provided by a standalone application, a service or hosted service (standalone or in combination with another hosted service), or a plug-in to another product, to name a few. In addition, methods 500, 600, and 700 are described, by way of example, with respect to the information management system 200 of FIG. 2 and additional features of FIGS. 3 and 4. However, these methods may additionally or alternatively be executed by any one system, or any combination of systems, including, but not limited to, those described herein.

FIG. 5 is a flow diagram showing a method 500 for enforcing a privacy policy on data output from a knowledge graph, in accordance with some embodiments of the present disclosure. The method 500, at block 510 includes receiving, from a service, a query seeking information from a knowledge graph. The service may be designated as an application and/or a function performed by one or more applications. For example, the service may be an analytics program, document management program, file-editing application (e.g., word processing application, spreadsheet application). Thus, the service could be designated as analytics, regardless of the program performing the analytics. The query may include specific information, such as a definition of the requested information (e.g., how many users have performed an action (e.g., view, open, edit) on each file in the knowledge graph). The request may also specify an intended audience that will see a result and a requesting service. In one aspect, the query is submitted with a token that includes information, such as the requesting service, search parameters, and intended audience. The information specified in the token can correspond to information in a privacy policy. The information specified in the token can be used to determine what information is responsive to the query and whether the audience or service may access the requested information.

The method 500, at block 520 includes determining that a privacy policy associated with the knowledge graph applies to the service and restricts the service from accessing information about a first plurality of objects in the knowledge graph. The privacy policy could be an organizational privacy policy and or a group privacy policy. In one aspect, the privacy policy takes the form of an opt-out record, such as organizational opt-out record 226 or user opt-out record 228. Determining that a privacy policy applies to the first plurality of objects may comprise analyzing the privacy policy of multiple users.

The method 500, at block 530 includes generating a preliminary result set comprising objects in the knowledge graph that are responsive to the query. The preliminary result set may be generated without reference to a privacy policy. For example, the query may seek all edges of a first type. In this example, all edges of the first type may be the preliminary result set. Each edge may be between a user and a file. The first type could be a particular action, such as editing or emailing a document.

The method 500, at block 540 includes generating a final-result set comprising the preliminary result set with the first plurality of objects removed. Following the example above, the first plurality of objects could be edges intersecting a user with a privacy policy restricting access to the edge of the first type. The first type could be specifically identified or the privacy policy could block access to all edges intersecting the user node.

The method 500, at block 550 includes outputting a query result that is based on the final-result set. The query result could be analytics data derived from the final-result set, such as how many edges of the first type intersect each file. In this example, the result would not be accurate because it is not based on all edges, but only on unrestricted edges. In one aspect, the requesting service is made aware that the data is incomplete because of privacy restrictions. The query result is not limited to analytics and could be data from the edges or nodes, such as list of users that edited a specific document.

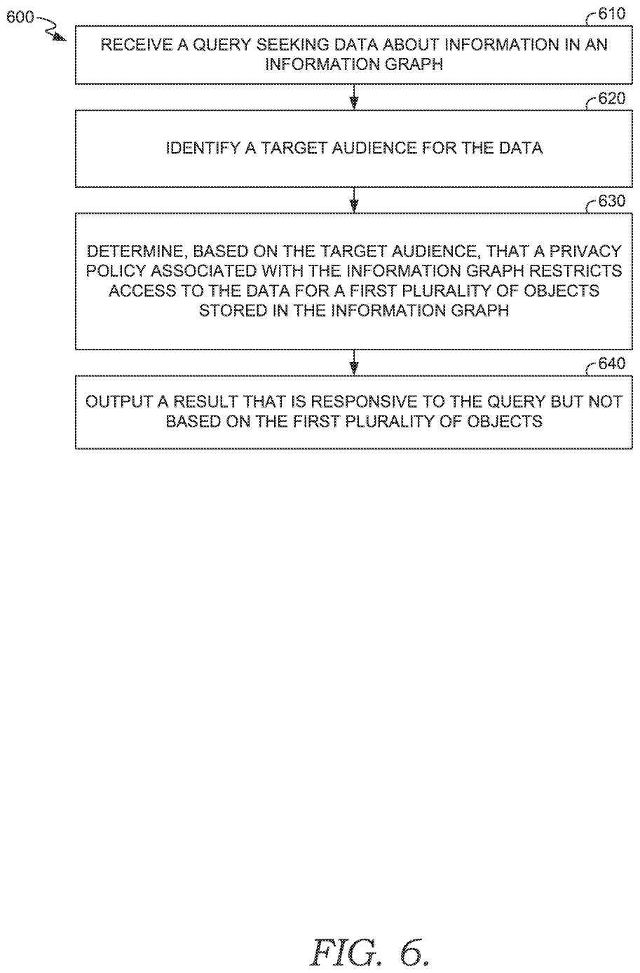

FIG. 6 is a flow diagram showing a method 600 for enforcing a privacy policy on data output from a knowledge graph, in accordance with some embodiments of the present disclosure. The method 600, at block 610 includes receiving a query seeking information from a knowledge graph. The query may include specific information, such as a definition of the requested information (e.g., how many users have performed an action (e.g., view, open, edit) on each file in the knowledge graph). The request may also specify an intended audience that will see a result and a requesting service. In one aspect, the query is submitted with a token that includes information, such as the requesting service, search parameters, and intended audience. The information specified in the token can correspond to information in a privacy policy. The information specified in the token can be used to determine what information is responsive to the query and whether the audience or service may access the requested information.

The method 600, at block 620 includes identifying a target audience for the information. In one aspect, the audience can be a single user or a group of users. The group can be identified by the individual users in the group or by a group identify, such as legal group, purchasing, technical support.

The method 600, at block 630 includes determining that a privacy policy associated with the knowledge graph restricts the target audience from accessing the information for a first plurality of objects stored in the knowledge graph. The audience for the information can be specified as a list of users or predefined groups. If the audience is not specified in a privacy policy, then it may be assumed to apply to all users within an organization. The privacy policy consulted can be an organizational privacy policy or an individual user policy. The preliminary result set may be generated without reference to a privacy policy. For example, the query may seek all edges of a first type. In this example, all edges of the first type may be the preliminary result set. Each edge may be between a user and a file. The first type could be a particular action, such as editing or emailing a document.

The method 600, at block 640 includes generating a final-result set comprising objects that are responsive to the query with the first plurality of objects removed. Following the example above, the first plurality of objects could be edges intersecting a user with a privacy policy restricting access to the edge of the first type for the intended audience. The first type could be specifically identified or the privacy policy could block access to all edges intersecting the user node. Similarly, the audience could be specifically identified.

The method 600, at block 650 includes outputting a result that is based on the final-result set. The query result could be analytics data derived from the final-result set, such as how many edges of the first type intersect each file. In this example, the result would not be accurate because it is not based on all edges, but only on unrestricted edges. In one aspect, the requesting service is made aware that the data is incomplete because of privacy restrictions. The query result is not limited to analytics and could be data from the edges or nodes, such as list of users that edited a specific document.

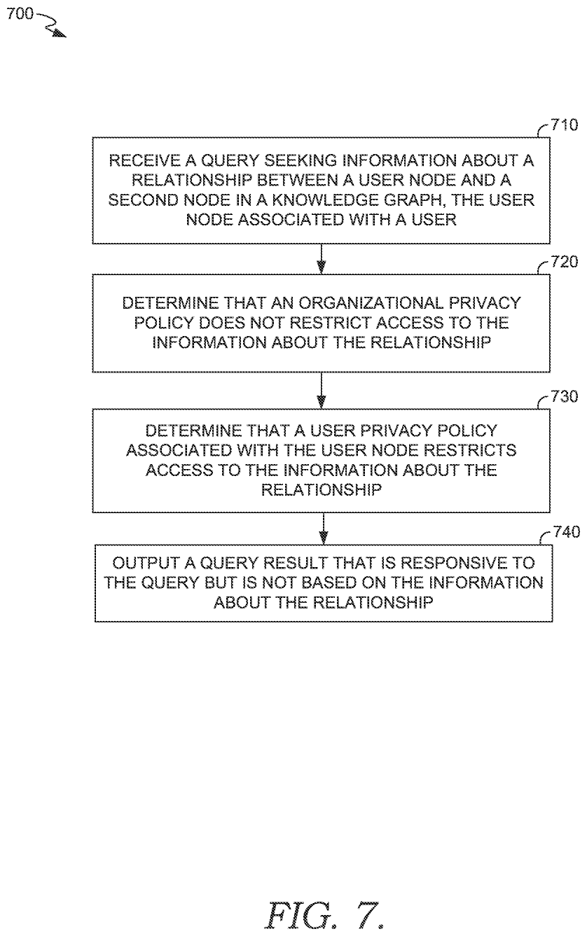

FIG. 7 is a flow diagram showing a method 700 for enforcing a privacy policy on data output from a knowledge graph, in accordance with some embodiments of the present disclosure. The method 700, at block 710 includes receiving a query seeking information about a relationship between a user node and a second node in a knowledge graph, the user node associated with a user. The query may include specific information, such as a definition of the requested information (e.g., how many users have performed an action (e.g., view, open, edit) on each file in the knowledge graph). The request may also specify an intended audience that will see a result and a requesting service. In one aspect, the query is submitted with a token that includes information, such as the requesting service, search parameters, and intended audience. The information specified in the token can correspond to information in a privacy policy. The information specified in the token can be used to determine what information is responsive to the query and whether the audience or service may access the requested information.

The method 700, at block 720 includes determining that an organizational privacy policy does not restrict access to the information about the relationship. In response to receiving the request, the organizational privacy policies may be inspected by the privacy-policy enforcement component 250 to determine if the requested information is governed by a privacy policy. For example, the privacy policies may be inspected to determine if a privacy policy is applicable to a particular requesting service. The information requested is evaluated to determine whether any portion thereof is restricted by an organizational policy. The audience specified by the request may also be used to determine whether any portion of the requested information is restricted. The restricted information may be identified and trimmed from any results provided. Objects restricted by the organizational privacy policy may be described as organizationally restricted objects. If at least some objects exist that are responsive to the query and are not restricted, then user privacy policies may be evaluated. Otherwise, a response may be provided indicating that no objects are responsive to the query.

The method 700, at block 730 includes determining that a user privacy policy associated with the user node restricts access to the information about the relationship. The user privacy policies may be evaluated in the same or similar way that organizational policies are evaluated. The responsive information may be first identified and then compared against privacy policies to see if any of the user privacy policies restrict the requested information. Any restricted information may be described as user-restricted objects. The result set may be generated to include objects that are responsive the query but that are not user restricted objects or organizationally restricted objects. For example, in response to a query seeking a number of views for a plurality of documents, a response may be provided that is less than the total number of actual views. The number provided would not include views associated with users having privacy policies or organization privacy policies restricting the records.

The method 700, at block 740 includes outputting a query result that is responsive to the query but is not based on the information about the relationship. The query result could be analytics data, such as how many edges of the first type intersect each file. In this example, the result would not be accurate because it is not based on all relationships, but only on unrestricted relationships. In one aspect, the requesting service is made aware that the data is incomplete because of privacy restrictions. The query result is not limited to analytics and could be data from the edges or nodes, such as list of users that edited a specific document.

### Exemplary Operating Environment

Referring to the drawings in general, and initially to FIG. 8 in particular, an exemplary operating environment for implementing aspects of the technology described herein is shown and designated generally as computing device 800. Computing device 800 is but one example of a suitable computing environment and is not intended to suggest any limitation as to the scope of use of the technology described herein. Neither should the computing device 800 be interpreted as having any dependency or requirement relating to any one or combination of components illustrated.

The technology described herein may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, specialty computing devices, etc. Aspects of the technology described herein may also be practiced in distributed computing environments where tasks are performed by remote-processing devices that are linked through a communications network.

With continued reference to FIG. 8, computing device 800 includes a bus 810 that directly or indirectly couples the following devices: memory 812, one or more processors 814, one or more presentation components 816, input/output (I/O) ports 818, I/O components 820, and an illustrative power supply 822. Bus 810 represents what may be one or more busses (such as an address bus, data bus, or a combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 8 is merely illustrative of an exemplary computing device that can be used in connection with one or more aspects of the technology described herein. Distinction is not made between such categories as “workstation,” “server,” “laptop,” “handheld device,” etc., as all are contemplated within the scope of FIG. 8 and refer to “computer” or “computing device.”

Computing device 800 typically includes a variety of computer-readable media. Computer-readable media can be any available media that can be accessed by computing device 800 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 812 includes computer storage media in the form of volatile and/or nonvolatile memory. The memory 812 may be removable, non-removable, or a combination thereof. Exemplary memory includes solid-state memory, hard drives, optical-disc drives, etc. Computing device 800 includes one or more processors 814 that read data from various entities such as bus 810, memory 812, or I/O components 820. Presentation component(s) 816 present data indications to a user or other device. Exemplary presentation components 816 include a display device, speaker, printing component, vibrating component, etc. I/O ports 818 allow computing device 800 to be logically coupled to other devices, including I/O components 820, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 814 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 800. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 800. The computing device 800 may be equipped with depth cameras, such as stereoscopic camera systems, infrared camera systems, RGB camera systems, and combinations of these, for gesture detection and recognition. Additionally, the computing device 800 may be equipped with accelerometers or gyroscopes that enable detection of motion. The output of the accelerometers or gyroscopes may be provided to the display of the computing device 800 to render immersive augmented reality or virtual reality.

A computing device may include a radio 824. The radio 824 transmits and receives radio communications. The computing device may be a wireless terminal adapted to receive communications and media over various wireless networks. Computing device 800 may communicate via wireless policies, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 policies.

### Embodiments

The technology described herein has been described in relation to particular aspects, which are intended in all respects to be illustrative rather than restrictive. While the technology described herein is susceptible to various modifications and alternative constructions, certain illustrated aspects thereof are shown in the drawings and have been described above in detail. It should be understood, however, that there is no intention to limit the technology described herein to the specific forms disclosed, but on the contrary, the intention is to cover all modifications, alternative constructions, and equivalents falling within the spirit and scope of the technology described herein.

What is claimed is:

1. One or more computer storage media comprising computer-executable instructions that when executed by a computing device cause the computing device to perform a method of enforcing a privacy policy on information output from a knowledge graph, comprising:
receiving, from a service, a query seeking information from a knowledge graph;
determining that a privacy policy associated with the knowledge graph applies to the service and restricts the service from accessing information about a first plurality of objects in the knowledge graph;
generating a preliminary result set comprising objects in the knowledge graph that are responsive to the query;
generating a final result set comprising the preliminary result set with the first plurality of objects removed; and
outputting a query result that is based on the final result set.

2. The media of claim 1, wherein the query seeks a number of a first relationship type between nodes representing a first type of object and nodes representing users, wherein the query does not seek information identifying the users.

3. The media of claim 2, wherein the privacy policy restricts access for the first relationship type but allows access for a second relationship type.

4. The media of claim 2, wherein the first type of object is a document and the first relationship type is viewing the document.

5. The media of claim 1, wherein the privacy policy is a group policy that applies to a subset of users represented by nodes in the knowledge graph.

6. The media of claim 1, wherein the privacy policy is stored in the knowledge graph.

7. The media of claim 6, wherein the privacy policy is stored in a floating node that does not contain an edge to other nodes in the knowledge graph.

8. A method of enforcing a privacy policy on information output from a knowledge graph, the method comprising:
receiving a query seeking information from a knowledge graph;
identifying a target audience for the information;
determining that a privacy policy associated with the knowledge graph restricts the target audience from accessing the information for a first plurality of objects stored in the knowledge graph;
generating a final result set comprising objects that are responsive to the query with the first plurality of objects removed; and
outputting a result that is based on the final result set.

9. The method of claim 8, wherein the information is an amount of objects in the knowledge graph that match a criterion specified in the query.

10. The method of claim 9, wherein the first plurality of objects are not counted when calculating the amount of objects provided in the result.

11. The method of claim 8, wherein the first plurality of objects are a first subset of edges intersecting nodes representing users and wherein the result is based on a second subset of edges intersecting the nodes.

12. The method of claim 8, wherein the privacy policy is stored in the knowledge graph.

13. The method of claim 8, further comprising forming the result by deleting information about the first plurality of objects from a preliminary result.

14. The method of claim 8, further comprising synchronizing the privacy policy for a user by:
determining that an organizational privacy status of an organization the user is associated with allows access;
determining that a group privacy status of a group the user is associated with allows access;
determining that a user privacy status in a profile of the user allows access; and
removing the user from the privacy policy.

15. The method of claim 8, wherein the determining that the privacy policy associated with the knowledge graph restricts access to the information for the first plurality of objects stored in the knowledge graph comprises:
determining that a first privacy status of a first user privacy policy associated with the knowledge graph restricts access to a first subset of the first plurality of objects;
determining that a second privacy status of a second user privacy policy associated with the knowledge graph restricts access to a second subset of the first plurality of objects; and
determining the first plurality of objects by combining the first subset and the second subset.

16. A method of enforcing a privacy policy on information output from a knowledge graph, comprising:
receiving a query seeking information about a relationship between a user node and a second node in a knowledge graph, the user node associated with a user;
determining that an organizational privacy policy does not restrict access to the information about the relationship;
determining that a user privacy policy associated with the user node restricts access to the information about the relationship; and
outputting a query result that is responsive to the query but is not based on the information about the relationship.

17. The method of claim 16, further comprising:
receiving a group opt-out instruction indicating a plurality of users including the user; and
updating the user privacy policy to indicate an opt-out instruction.

18. The method of claim 16, wherein the second node is a file, and wherein the relationship is selected from a group consisting of editing the file, viewing the file, sharing the file, or copying the file.

19. The method of claim 18, wherein the file is of a type selected from a group consisting of a document file, a spreadsheet file, a social media post file, an email file, a presentation file, or a meeting file.

20. The method of claim 16, wherein the privacy policy is stored in the knowledge graph.
